(19) United States
(12) Patent Application Publication
(10) Pub. No.: US 2025/0258308 A1
(43) Pub. Date: Aug. 14, 2025

(54) SENSOR SYSTEM COMPRISING A READOUT CIRCUIT AND METHOD FOR OPERATING A SENSOR SYSTEM COMPRISING A READOUT CIRCUIT

(71) Applicant: Robert Bosch GmbH, Stuttgart (DE)

(72) Inventors: Antonios Nikas, Muenchen (DE); Francesco Diazzi, Muenchen (DE)

(21) Appl. No.: 19/018,836

(22) Filed: Jan. 13, 2025

(30) Foreign Application Priority Data
Feb. 12, 2024 (DE) 10 2024 201 241.6

(51) Int. Cl. G01V 1/16; G01V 1/18

(52) U.S. Cl. CPC G01V 1/164; G01V 1/18

(57) ABSTRACT

A sensor system. The sensor system includes a readout circuit for a capacitive differential sensor output for acquiring an analog sensor output signal. The readout circuit includes: a capacitance-voltage converter, and a compensation device for compensating at least one parasitic impedance; wherein
the capacitance-voltage converter includes a converter input and wherein the capacitance-voltage converter acquires the sensor output signal at its converter input as an analog sensor output signal under the influence of both the at least one parasitic impedance and the compensation device, wherein the compensation device provides a further impedance component at the converter input which at least partially compensates the influence of the parasitic impedance.

### CROSS REFERENCE

The present application claims the benefit under 35 U.S.C. § 119 of German Patent Application No. DE 10 2024 201 241.6 filed on Feb. 12, 2024, which is expressly incorporated herein by reference in its entirety.

### FIELD

The present invention relates to a sensor system comprising a readout circuit.

### BACKGROUND INFORMATION

Sensor systems comprising seismic elements that are excited to oscillate, in particular resonant sensor systems with MEMS gyroscopes, place high demands on interface amplifiers or capacitance-voltage converters used within the readout circuit. It is necessary, on the one hand, that the interface amplifier or capacitance-voltage converter ensures a stable phase and a stable gain factor under a variety of operating conditions, and, on the other hand, that the interface amplifier or capacitance-voltage converter has functionality with respect to a wide range of parasitic impedances at the converter input of the capacitance-voltage converter. Critical parameters such as the noise behavior, linearity and power requirement of the sensor system depend heavily on the performance of the interface amplifier or capacitance-voltage converter and the influence of parasitic impedances on the converter input.

A variety of circuit methods for compensating or reducing the parasitic impedances (at the converter input) are described in the related art. However, since different applications in practice often involve different power requirements for different operating modes, for example for gyroscopes, in most cases optimal utilization of the sensor system represents a compromise between the required power and the gain values or noise components needed for the application. Adjusting the power requirements for operating the sensor system and the noise components associated with the gain values to a wide range is therefore advantageous and poses a challenge.

The way described in the related art to achieve this is readjusting the power consumption of the interface amplifier or capacitance-voltage converter. Due to the need to maintain stability and the effects on the parameters of the interface amplifier, however, this is only an inadequate option, because the effects on the parameters of the interface amplifier have to be compensated again with long testing times and high testing costs using readjustment procedures or, alternatively, the operating ranges have to be severely limited.

Capacitive high-performance MEMS, such as gyroscopes and acceleration sensors place high demands on their interface amplifiers (IA). On the one hand, the amplifier has to have a stable phase and gain under different operating conditions and at the same time be stable with a wide range of parasitic capacitances at its input nodes. On the other hand, noise behavior, linearity and performance of the overall system depend heavily on the interface amplifier

### SUMMARY

It is an object of the present invention to provide a sensor system comprising a readout circuit that does not have the aforementioned disadvantages.

A sensor system including certain features of the present invention may have an advantage over the related art that, on the one hand, the configurable capacitor arrangement provides the output signal of the compensation device corresponding to the further impedance component as the analog signal corresponding to a changeable capacitance at the converter input, and, on the other hand, can be adjusted via a digital input. For setting a respectively to be used operating and/or power mode, the compensation device further comprises a control input (for selecting the respectively to be used operating and/or power mode (operating mode selection)). Providing the analog signal corresponding to a changeable capacitance at the converter input at the converter input advantageously makes it possible to ensure efficient and effective operation of the sensor system, in particular with respect to the power requirements. The configurable capacitor arrangement can be efficiently adjusted using the digital input (hereinafter also referred to as “trim code X”).

The sensor system can furthermore likewise be operated effectively and efficiently for the application of different gain values and the resulting different noise components. The application of different gain values within specific operating modes (i.e. among other things during operation of changing operating modes) can moreover advantageously be optimized for specific uses (and does not have to be readapted for each application or for each operating mode using readjustment procedures). In addition, the influence of the parasitic impedance at the converter input with respect to the introduced phase difference and/or the gain factor and/or the stability can advantageously be diminished or greatly reduced for the operation of the sensor system. This allows the properties of the sensor system to be determined more specifically and the effort in terms of testing or adjustment times and the additional space requirement (and thus additional costs) to effectively be reduced. In addition to the mentioned advantages, costs can be saved as well, in particular in production.

The present invention may enable a much greater range of power and performance modes than the related art, while eliminating the effects on phase, gain and stability of the IA (capacitance-voltage converter). This not only simplifies the design of the interface amplifier significantly, but also reduces the testing time and the use of space to enable mode change.

The present invention may make it possible to:
adjust the power (power consumption and noise) of the front end over a wide range,
minimize the effects on other parameters of the front-end operation based on the power adjustment,
based on the aforementioned properties, the sensors can be optimized for a specific application and do not have to be reset for each operating mode, which saves costs.

Advantageous embodiments and further developments of the present invention are disclosed herein.

According to one advantageous example embodiment of the present invention, it is provided that the compensation device comprises an auxiliary amplifier, wherein the auxiliary amplifier has a gain factor greater than 2. It is thus advantageously possible that a simulation of the reference potential (virtual ground) of the capacitance-voltage converter is amplified by a gain factor typically greater than 2, but in particular less than 10. This forms the basis for the output signal of the compensation device, which corresponds to the analog signal corresponding to a changeable capacitance.

According to one advantageous example embodiment of the present invention, it is provided that the configurable capacitor arrangement is configured as a digital-to-analog converter with configurable capacitor array. This advantageously makes it possible to adapt the configurable capacitor arrangement for a wide range of different operating modes, in particular with respect to the use of different power requirements for operating the sensor system and/or the use of different gain values and consequently different noise components.

According to one advantageous example embodiment of the present invention, it is provided that the compensation device with the configurable capacitor arrangement and the auxiliary amplifier is capable of providing the further impedance component in such a way that the further impedance component corresponds to and substantially compensates the negative of the impedance caused by the parasitic impedance. This advantageously makes it possible to ensure effective and efficient operation.

According to one advantageous example embodiment of the present invention, it is provided that the operation of the compensation device and the compensation of the at least one parasitic impedance has the effect that the capacitance-voltage converter can be operated in a wide range of different operating modes according to the present invention, in particular such that the noise can be changed by a factor of 10 and the current consumption can thus be changed by a factor of 100), in particular
using different power requirements for operating the capacitance-voltage converter, and/or
using different gain values and consequently different noise components or changing the noise by changing the open-loop parameters of the auxiliary amplifier (such as current consumption or the transconductance). It is thus advantageously possible to ensure effective and efficient operation.

According to one advantageous example embodiment of the present invention, it is provided that the operation of the compensation device has the effect that the influence on the operation of the capacitance-voltage converter related to
the introduced phase difference and/or
the gain factor and/or
the stability
   disappears or is at least greatly reduced, or is minimized over a wide operating range of the capacitance-voltage converter. This advantageously results in effective and efficient operation of the sensor system.

A further subject matter of the present invention is a method for operating a sensor system comprising a readout circuit according to the present invention.

The method according to the present invention for operating a sensor system comprising a readout circuit proves to be advantageous over the related art in that the configurable capacitor arrangement
on the one hand, provides the output signal of the compensation device corresponding to the further impedance component and the analog signal corresponding to a changeable capacitance at the converter input, and
on the other hand, comprises a digital input for setting the operating state of the configurable capacitor arrangement.

It is thus advantageously possible to ensure efficient and effective operation of the sensor system, in particular the capacitance-voltage converter, using different power requirements by providing the analog signal corresponding to a changeable capacitance. The digital input (hereinafter also referred to as “trim code X”) effectively and efficiently enables the use of a compensation signal to set an operating state of the configurable capacitor arrangement.

The method according to the present invention can moreover also be used to operate the sensor system in a wide range of different operating modes. This relates in particular to the use of different power requirements for operating the sensor system and/or the use of different gain values and the resulting different noise components. The operation according to the present invention of the sensor system furthermore results in an efficient and effective compensation or a sharp reduction of the influence (on the operation of the capacitance-voltage converter) with respect to the phase difference introduced by the parasitic impedance and/or the gain factor and/or the stability over a wide operating range. The design of the capacitance-voltage converter can also be adapted effectively and efficiently and the testing or adjustment time and the space requirement can be effectively and efficiently reduced. The mentioned advantages moreover also allow costs to be saved, in particular in the production of the sensor system to be operated.

The present invention may enable a much greater range of power and performance modes than previous architectures, while eliminating or at least greatly reducing the effects on phase, gain and stability of the IA (capacitance-voltage converter). This not only simplifies the design of the interface amplifier significantly, but also reduces the testing time and the use of space, or the (wafer) surface requirement, to enable mode change.

The present invention may make it possible to:
adjust the power (power consumption and noise) of the front end (the readout circuit) over a wide range,
minimize the effects on other parameters of the front-end operation based on the power adjustment,
based on the aforementioned properties, the sensors can be optimized for a specific application and do not have to be reset for each operating mode, which saves costs, in particular also the time required to adjust components during their production.

The advantages and configurations described in connection with the example embodiments of the sensor system according to the present invention comprising a readout circuit can be applied to the method for operating a sensor system comprising a readout circuit, according to the present invention.

Embodiment examples of the present invention are shown in the figures and explained in more detail in the following description.

### BRIEF DESCRIPTION OF THE DRAWINGS

FIG. 1 schematically shows an equivalent circuit diagram of the sensor system comprising a readout circuit according to the related art.

FIG. 2 schematically shows an equivalent circuit diagram of the sensor system comprising a readout circuit to illustrate an example procedure according to the present invention.

FIG. 3 schematically shows a circuit diagram of the sensor system comprising a readout circuit according to an example embodiment of the present invention.

FIG. 4 schematically shows a circuit diagram of the sensor system comprising a readout circuit or a part thereof according to an example embodiment of the present invention.

### DETAILED DESCRIPTION OF EXAMPLE EMBODIMENTS

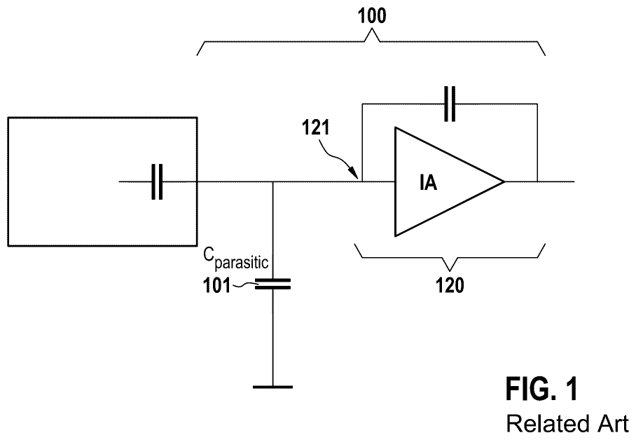

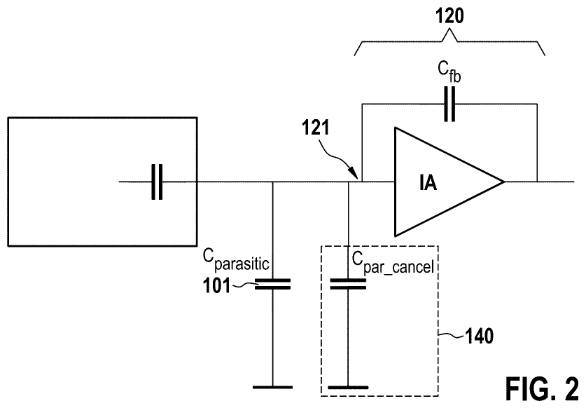

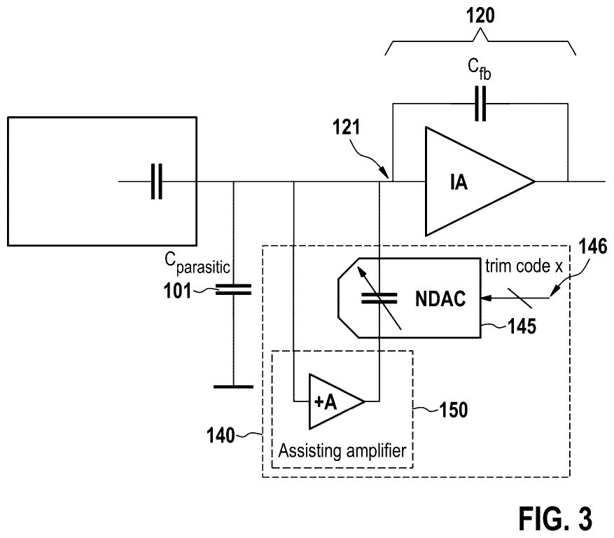

FIG. 1 schematically shows an equivalent circuit diagram of the sensor system comprising a readout circuit 100 according to the related art. The micromechanical structure with a capacitive (in particular differential) sensor output, i.e. a capacitive sensor (schematically depicted in FIG. 1 and the following FIGS. 2 and 3 by means of a rectangle with a capacitance symbol), is excited to oscillate in a conventional manner and an analog sensor output signal is typically forwarded via a capacitive differential sensor output to a readout circuit 100 which is coupled to the capacitive sensor. In addition, the influence of a (or at least one) parasitic impedance 101 is schematically depicted in the form of an equivalent circuit diagram. An interface amplifier or capacitance-voltage converter 120 with a converter input 121 of the interface amplifier and/or capacitance-voltage converter 120 is shown as well. The analog sensor output signal is present at the converter input 121 under the influence of the (at least one) parasitic impedance 101. Specifically, the interface amplifier or capacitance-voltage converter 120 acquires the analog sensor output signal at its converter input 121 under the influence of the (at least one) parasitic impedance 101. The parasitic impedance 101 (or the plurality of parasitic impedances) results in particular from a combination of sensor, housing, and circuit parasitic effects, wherein these are examples and other environment-dependent sources of the parasitic impedances are possible or occur. These have an effect on the loop gain of the interface amplifier or capacitance-voltage converter 120 and therefore on several parameters of the sensor system, including on the output noise of the interface amplifier or capacitance-voltage converter 120.

FIG. 2 schematically shows an equivalent circuit diagram of the sensor system comprising a readout circuit 100 to illustrate the procedure according to the present invention. The micromechanical structure of the capacitive sensor is excited to oscillate in a conventional manner and the analog sensor output signal is forwarded via the capacitive differential sensor output to the readout circuit 100. The figure furthermore shows the (at least one) parasitic impedance 101 as an equivalent circuit diagram and the interface amplifier or capacitance-voltage converter 120 and its converter input 121. To at least partially compensate the effect of the parasitic impedance, a compensation device 140 is shown according to the present invention, which has the effect that the analog sensor output signal is present at the converter input 121 under the influence of the (at least one) parasitic impedance 101 and under the influence of the compensation device 140. The influence of the compensation device 140 at the converter input 121 relates to a further impedance component, which is provided by the output signal of the compensation device 140 and at least partially compensates the influence of the parasitic impedance 101.

FIG. 3 schematically shows a circuit diagram of the sensor system comprising a readout circuit 100 according to the present invention. The micromechanical structure of the capacitive sensor is excited to oscillate in a conventional manner and the analog sensor output signal is forwarded via the capacitive differential sensor output to the readout circuit 100. The figure furthermore shows the (at least one) parasitic impedance 101 in the form of an equivalent circuit diagram, the interface amplifier or capacitance-voltage converter 120, its converter input 121 and the compensation device 140. Again, the analog sensor output signal is present at the converter input 121 under the influence of the (at least one) parasitic impedance 101 and under the influence of the compensation device 140.

According to an embodiment of the present invention shown as an example, an auxiliary amplifier 150 having a gain factor of typically greater than 2 is disposed within the compensation device 140. A configurable capacitor arrangement 145, which comprises a digital input 146 for setting an operating state of the configurable capacitor arrangement 145, is shown as well. In the embodiment shown as an example, the configurable capacitor arrangement is configured as a digital-to-analog converter with configurable capacitor array.

The influence of the compensation device 140 at the converter input 121 relates to the further impedance component, which is provided as the output signal of the compensation device 140. Within the compensation device 140, the output signal is provided at the output of the configurable capacitor arrangement 145 as an analog signal corresponding to a changeable capacitance. The compensation device 140 is capable of providing the further impedance component by means of the configurable capacitor arrangement 145 and the auxiliary amplifier 150 in such a way that the further impedance component corresponds to and substantially compensates the negative of the impedance caused by the parasitic impedance.

A setting of the configurable capacitor arrangement 145 is moreover fed in or such a setting is carried out via the digital input 146 by means of a compensation signal (also referred to hereinafter as “trim code X”). This advantageously brings about an adjustment of the output signal of the compensation device 140 and can be adapted with respect to different operating modes, for example using different power requirements for operating the interface amplifier or capacitance-voltage converter 120 and/or using different gain values and consequently different noise components.

FIG. 3 thus represents a design variant according to the present invention, which shows an implementation of the compensation device 140. The auxiliary amplifier 150 with a gain of +A and the digital-to-analog converter with configurable capacitor array are used to implement the compensation device 140. The auxiliary amplifier 150 generates a simulation of the reference potential (virtual ground) of the interface amplifier or capacitance-voltage converter 120 with a gain of typically more than 2. The gain A can be selected to be larger if needed to reduce the memory requirements of the digital-to-analog converter with configurable capacitor array. If the capacitive influence at the reference potential (virtual ground) of the interface amplifier or capacitance-voltage converter 120 dominates the noise gain and this is canceled by the compensation device 140, the noise power is now dominated by the compensation device 140. More specifically, in the implementation of FIG. 3, this would be the auxiliary amplifier 150 with the gain A.

The noise gain NG_{IA} of the interface amplifier or capacitance-voltage converter 120 can be described as follows:

$$N {G}_{IA} = \frac{{C}_{p a r a s i t i c} - {C}_{p a r - c a n c e l}}{{C}_{f b}} + 1$$

while the noise NG_{assisting-amplifier} of the auxiliary amplifier 150 is amplified as follows:

$$N {G}_{a s sisting - amplifier} = \frac{{C}_{N D A C}}{{C}_{f b}} * A$$

C_{parasitic} is the (at least one) parasitic impedance 101 at the converter input 121 of the interface amplifier or capacitance-voltage converter 120, C_{par-cancel} is the capacitance of the compensation device 140 that is introduced to (partially or completely) cancel C_{parasitic}, C_{NDAC} is the capacitance of the digital-to-analog converter with configurable capacitor array and C_{fb} is the capacitance of the feedback capacitor of the interface amplifier or capacitance-voltage converter 120.

It should be noted that, according to the present invention, the requirements for the auxiliary amplifier 150 are much lower than for the interface amplifier or capacitance-voltage converter 120. The auxiliary amplifier 150 sees only the very small signals of the virtual ground of the interface amplifier or capacitance-voltage converter 120 and requires only a comparatively low gain in the closed-loop control. This amplifier 150 can therefore be implemented with a much simpler architecture than the interface amplifier or capacitance-voltage converter 120 and can consequently easily be implemented with a wide range of power modes or operating modes. Due to the impedance cancellation by the auxiliary amplifier 150, the phase delay, the loop gain and the stability of the interface amplifier or capacitance-voltage converter 120 depend primarily only on the control loop characteristic of the auxiliary amplifier 150 and the digital-to-analog converter with configurable capacitor array. The dependence of the parameters of the interface amplifier or capacitance-voltage converter 120 depends primarily only on the closed-loop characteristic of the auxiliary amplifier 150 and the dependence of these parameters of the interface amplifier on the open-loop characteristic of the auxiliary amplifier 150 is low. According to the present invention, it is advantageously preferably provided that the amplifier 150 (which can be implemented with a much simpler architecture than the interface amplifier or capacitance-voltage converter 120) be operated in a wide range of power modes or operating modes. For this purpose, it is in particular provided according to the present invention that the amplifier 150 is provided for operation in different operating modes and/or power modes, and in particular comprises a control input for selecting the respectively to be used operating and/or power mode (operating mode selection) (for the sake of simplicity, however, this control input is not shown in FIG. 3).

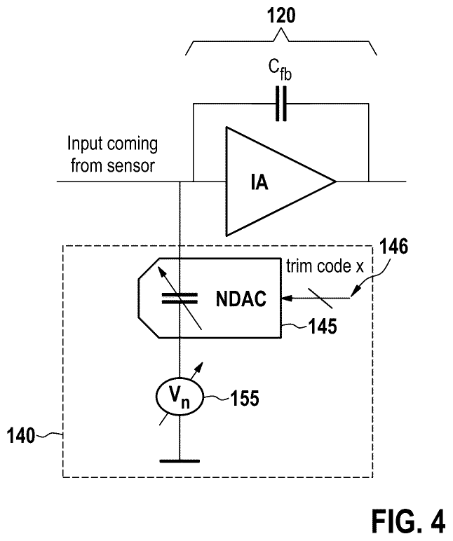

FIG. 4 schematically shows a circuit diagram of the sensor system comprising a readout circuit 100 or a part thereof according to the present invention. The figure shows the interface amplifier or capacitance-voltage converter 120 and the compensation device 140, which in this embodiment comprises the configurable capacitor arrangement 145 as shown in the illustration in FIG. 3. An adjustable voltage noise source 155, which can be used to model the auxiliary amplifier 150, is shown as an equivalent circuit diagram.

The auxiliary amplifier 150 can thus be modeled using the adjustable voltage noise source 155, so that this adjustable voltage noise source is amplified at a converter output of the interface amplifier or capacitance-voltage converter 120 by the capacitance ratio C_{NDAC}/C_{fb}. According to the present invention, it is therefore possible to operate the interface amplifier or capacitance-voltage converter 120 in a variety of operating modes both during a switching-on process and during operation, or, among other things, also change the different operating modes during operation. Operating modes with a low power requirement and a high noise component, an average power requirement and an average noise component and a high power requirement and a low noise component can be implemented, for instance, or the interface amplifier 120 can be operated in these operating modes. According to the present invention, it is advantageously preferably provided that the adjustable voltage noise source 155 (and thus the auxiliary amplifier 150) be operated in a wide range of power modes or operating modes. For this purpose, it is in particular provided according to the present invention that the adjustable voltage noise source 155 is provided for operation in different operating modes and/or power modes, and in particular comprises a control input for selecting the respectively to be used operating and/or power mode (operating mode selection) (for the sake of simplicity, however, this control input, too, is not shown in FIG. 4). The compensation is moreover carried out here as well with the aid of the configurable capacitor arrangement 145, wherein the configurable capacitor arrangement 145 can be changed by means of the digital input 146 (trim code X), but both the compensation capacitance (of the configurable capacitor arrangement 145) and the feedback capacitance remain stable at their set value-even for different respectively to be used operating and/or power modes of the adjustable voltage noise source 155 selected by means of the control input.

What is claimed is:

1. A sensor system comprising a readout circuit for a capacitive sensor output for acquiring an analog sensor output signal, wherein the readout circuit includes:
a capacitance-voltage converter; and
a compensation device configured to compensate at least one parasitic impedance;
wherein the capacitance-voltage converter includes a converter input, and the capacitance-voltage converter is configured to acquires the analog sensor output signal at a converter input of the capacitance-voltage converter under an influence of both the at least one parasitic impedance and the compensation device,
wherein the compensation device is configured to provide a further impedance component at the converter input which at least partially compensates the influence of the parasitic impedance, and
wherein the compensation device includes a configurable capacitor arrangement, wherein the configurable capacitor arrangement is configured to provide at an output of the configurable capacitor arrangement an output signal of the compensation device corresponding to the further impedance component as an analog signal corresponding to a changeable capacitance at the converter input, wherein the configurable capacitor arrangement includes a digital input configured to set the configurable capacitor arrangement.

2. The sensor system according to claim 1, wherein the compensation device includes an auxiliary amplifier, wherein the auxiliary amplifier has a gain factor greater than 2, wherein the auxiliary amplifier is implemented more simply the capacitance-voltage converter and can be operated in a wide range of different power and/or operating modes, so that, due to the at least partial compensation of the parasitic impedance by the compensation device, a phase delay, loop gain, and stability of the capacitance-voltage converter depend primarily only on a control loop characteristic of the auxiliary amplifier and a digital-to-analog converter with configurable capacitor array.

3. The sensor system according to claim 1, wherein the configurable capacitor arrangement is configured as the digital-to-analog converter with configurable capacitor array.

4. The sensor system according to claim 2, wherein the compensation device with the configurable capacitor arrangement and the auxiliary amplifier is capable of providing the further impedance component in such a way that the further impedance component corresponds to and substantially compensates a negative of the impedance caused by the parasitic impedance.

5. The sensor system according to claim 1, wherein operation of the compensation device and the compensation of the at least one parasitic impedance has an effect that the capacitance-voltage converter can be operated in a wide range of different operating modes:
using different power requirements for operating the capacitance-voltage converter, and/or
using different gain values and different noise components.

6. The sensor system according to claim 1, wherein operation of the compensation device has an effect that an influence on the operation of the capacitance-voltage converter related to:
an introduced phase difference, and/or
a gain factor, and/or
stability,
disappears or is at least greatly reduced, or is minimized over a wide operating range of the capacitance-voltage converter.

7. A method for operating a sensor system including a readout circuit for a capacitive differential sensor output for acquiring an analog sensor output signal, wherein the readout circuit includes:
a capacitance-voltage converter including a converter input, and
a compensation device configured to compensate at least one parasitic impedance, and including a configurable capacitor arrangement, wherein the configurable capacitor arrangement includes a digital input for setting the configurable capacitor arrangement;
the method comprising:
acquiring the analog sensor output signal at a converter input of the capacitance-voltage converter under an influence of both the at least one parasitic impedance and the compensation device;
providing, by the compensation device, a further impedance component at the converter input which at least partially compensates the influence of the parasitic impedance; and
providing, by the configurable capacitor arrangement at an output of the configurable arrangement, an output signal of the compensation device corresponding to the further impedance component as an analog signal corresponding to a changeable capacitance at the converter input.
